(19) United States
(12) Patent Application Publication
(10) Pub. No.: US 2015/0192748 A1
(43) Pub. Date: Jul. 9, 2015

(54) OPTICAL FIBER CABLE FOR AIR BLOW INSTALLATION

(71) Applicant: SUMITOMO ELECTRIC INDUSTRIES, LTD., Osaka (JP)

(72) Inventors: Fumiaki SATO, Yokohama-shi (JP); Keisuke OKADA, Yokohama-shi (JP)

(21) Appl. No.: 14/591,488

(22) Filed: Jan. 7, 2015

(30) Foreign Application Priority Data
Jan. 8, 2014 (JP) 2014-001940

(51) Int. Cl. G02B 6/44

(52) U.S. Cl. CPC G02B 6/4403; G02B 6/443

(57) ABSTRACT

An optical fiber cable to be installed by air blow installation includes an optical fiber ribbon having a plurality of optical fibers arranged in parallel, the plurality of optical fibers being intermittently coupled to each other in a longitudinal direction, and a jacket made of a foamed resin and configured to cover a periphery of an optical fiber assembly formed by assembling together the plurality of optical fibers of the optical fiber ribbon.

### CROSS-REFERENCE TO RELATED APPLICATION

The present application claims the benefit of priority of Japanese Patent Application No. 2014-001940 filed on Jan. 8, 2014. The disclosures of the application are incorporated herein by reference.

### BACKGROUND

1. Technical Field

The present disclosure relates to an optical fiber cable to be installed by air blow installation.

2. Related Art

Patent Document 1 discloses an optical fiber cable to be installed in a micro duct by blowing the compressed air into the duct (air blow installation). In the optical fiber cable, three or four rod-shaped tensile-strength members composed of fiber-reinforced plastic (FRP) are stranded around a tube having a plurality of optical fibers accommodated therein. Also, in the optical fiber cable, a tensile-strength member is embedded as a cable jacket.

[Patent Document 1] Japanese Patent Application Publication No. 2010-204368A

Since the above optical fiber cable has the tube for accommodating therein the plurality of optical fibers and the plurality of tensile-strength members stranded together with the tube, a weight and a diameter of the optical fiber cable are inevitably increased. For this reason, when the optical fiber cable is installed in the duct by blowing the compressed air into the duct, the optical fiber cable is difficult to ride on an air flow, so that the installation operation may not be performed smoothly and favorably.

Also, according to the above optical fiber cable, since the optical fibers are accommodated in the tube, the tube becomes an obstacle, so that it is difficult to perform terminal processing of the optical fibers at a cable terminal. In this case, when a string for tube tearing is provided in the tube, it is possible to perform the terminal processing by tearing the optical fiber tube. However, the string for tearing is provided, so that the weight and diameter are further increased and the installation operation by the air blow installation is more difficult.

### SUMMARY

Exemplary embodiments of the invention provide an optical fiber cable for air blow installation of which terminal processing can be easily performed and enabling an installation operation by air blow installation to be smoothly and favorably performed.

An optical fiber cable to be installed by air blow installation according to an exemplary embodiment of the present invention comprises an optical fiber ribbon having a plurality of optical fibers arranged in parallel, the plurality of optical fibers being intermittently coupled to each other in a longitudinal direction, and a jacket made of a foamed resin and configured to cover a periphery of an optical fiber assembly formed by assembling together the plurality of optical fibers of the optical fiber ribbon.

According to the present invention, it is possible to provide the optical fiber cable for air blow installation of which terminal processing can be easily performed and enabling an installation operation by air blow installation to be smoothly and favorably performed.

### BRIEF DESCRIPTION OF THE DRAWINGS

FIG. 1 is a sectional view of an optical fiber cable for air blow installation according to an exemplary embodiment.

FIG. 2 is a plan view of an optical fiber ribbon configuring the optical fiber cable for air blow installation.

FIG. 3 is a sectional view of an optical fiber cable for air blow installation according to a comparative example.

FIG. 4 is a perspective view of an optical ribbon assembly of an optical fiber cable for air blow installation according to a modified embodiment.

FIG. 5 is a schematic configuration view of an apparatus of manufacturing an optical fiber ribbon.

FIG. 6A is a sectional view of the optical fiber ribbon in a width direction at cutting parts by upstream-side cutters of an intermittent processing apparatus.

FIG. 6B is a sectional view of the optical fiber ribbon in the width direction at cutting parts by downstream-side cutters of an intermittent processing apparatus.

### DETAILED DESCRIPTION

### Outline of Exemplary Embodiment of Present Invention

First, an outline of exemplary embodiments of the present invention is described.

(1) An optical fiber cable to be installed by air blow installation according to an exemplary embodiment of the present invention includes an optical fiber ribbon having a plurality of optical fibers arranged in parallel, the plurality of optical fibers being intermittently coupled to each other in a longitudinal direction, and a jacket made of a foamed resin and configured to cover a periphery of an optical fiber assembly formed by assembling together the plurality of optical fibers of the optical fiber ribbon.

According to the above configuration (1), the optical fiber ribbon of which the plurality of optical fibers is intermittently coupled to each other in the longitudinal direction is used, without using a tube for collecting and accommodating therein the plurality of optical fibers. Since the optical fiber ribbon has the plurality of optical fibers, which is integrated but intermittently coupled to each other in the longitudinal direction, it is possible to easily assemble the optical fibers adjacent to each other and thus to easily form the optical fiber assembly having a small diameter. Also, it is not necessary to provide a tube for accommodating therein the optical fibers and a tearing string for tearing the tube, so that it is possible to reduce a weight and a diameter of the cable. Thereby, when the optical fiber cable is installed in a duct by blowing the compressed air into the duct, the optical fiber cable is easy to ride on the air flow and to thus perform the installation operation smoothly and favorably.

Also, when the optical fiber ribbon is rubbed in the longitudinal direction by a brush, for example, the coupling parts of the optical fibers are separated and the optical fibers can be thus easily individually separated, so that the terminal processing can be easily performed.

(2) The optical fibers adjacent to each other of the optical fiber ribbon may be intermittently coupled to each other at alternately different positions in the longitudinal direction.

According to the above configuration (2), it is easy to assemble the optical fibers adjacent to each other, so that it is possible to easily form the optical fiber assembly having a small diameter.

(3) An optical ribbon assembly obtained by stranding a plurality of the optical fiber assemblies may be provided, and a periphery of the optical ribbon assembly may be covered with the jacket.

According to the above configuration (3), the optical ribbon assembly obtained by stranding the plurality of optical fiber assemblies is provided to increase the data communication capacity. Therefore, it is possible to meet the needs for the increase in the data communication capacity. Further, since it is possible to reduce the weight and diameter of the cable, while the plurality of optical fiber assemblies is provided to increase the data communication capacity, it is possible to perform the installation operation smoothly and favorably when the cable is installed in the duct by blowing the compressed air into the duct.

(4) A surface of the jacket may be formed with a concavo-convex part having a shape conforming to an outward shape of the optical fiber assembly.

According to the above configuration (4), since the concavo-convex part formed on the surface of the jacket is contacted to an inner surface of the duct, it is possible to reduce a contact area with the inner surface of the duct as much as possible when the cable is installed in the duct by blowing the compressed air into the duct. Thereby, it is possible to suppress the friction with the inner surface of the duct when the cable is installed in the duct by blowing the compressed air into the duct, so that it is possible to perform the installation operation smoothly and favorably.

(5) The optical fiber ribbon may be provided with an identification mark.

According to the above configuration (5), it is possible to easily identify the optical fiber assembly composed of the optical fiber ribbon and to smoothly perform a wiring operation at a terminal by seeing the identification mark. In particular, when a plurality of the optical fiber assemblies is provided, it is possible to easily identify each optical fiber assembly.

(6) A fiber-like material may be wound on the optical fiber assembly.

According to the above configuration (6), the fiber-like material is wound on the optical fiber assembly, so that it is possible to unify the optical fiber assembly. Thus, it is possible to easily handle the optical fiber assembly when the cable is installed. In particular, when a plurality of the optical fiber assemblies is provided, it is possible to easily identify the respective optical fiber assemblies by making colors or patterns of the fiber-like materials different.

(7) A fiber-like material may be wound on the optical ribbon assembly.

According to the above configuration (7), the fiber-like material is wound on the optical ribbon assembly consisting of the plurality of optical fiber assemblies, so that it is possible to unify the optical ribbon assembly and to easily handle the same when the cable is installed.

(8) The four optical fiber assemblies, each of which consists of the optical fiber ribbon having the twelve optical fibers, may be stranded to form the optical ribbon assembly.

According to the above configuration (8), since the forty eight optical fibers are provided, it is possible to increase the data communication capacity of the entire cable, so that it is possible to meet the needs for the increase in the data communication capacity. In this way, while the entire cable is made to be light and to have a small diameter, it is possible to meet the needs for the increase in the data communication capacity.

(9) The four optical fiber assemblies, each of which consists of the optical fiber ribbon having the six optical fibers, may be stranded to form the optical ribbon assembly.

According to the above configuration (9), since the twenty four optical fibers are provided, it is possible to increase the data communication capacity of the entire cable, so that it is possible to meet the needs for the increase in the data communication capacity. In this way, while the entire cable is made to be light and to have a small diameter, it is possible to meet the needs for the increase in the data communication capacity.

### Details of Exemplary Embodiment of Present Invention

Hereinafter, exemplary embodiments of the optical fiber cable for air blow installation according to the present invention will be described with reference to the drawings. In the meantime, the present invention is not limited to the exemplary embodiments and is defined in the claims, and includes all changes within the equivalent meaning and scope to the claims.

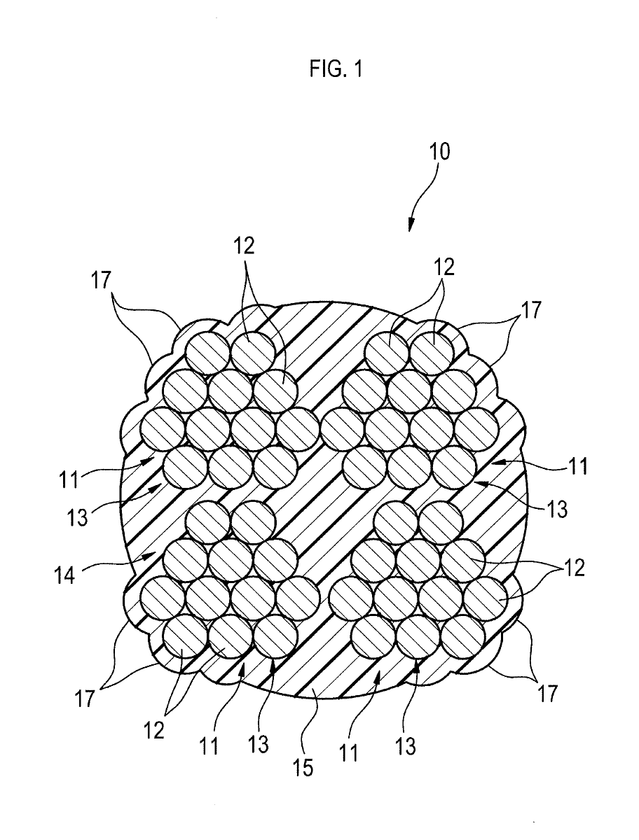

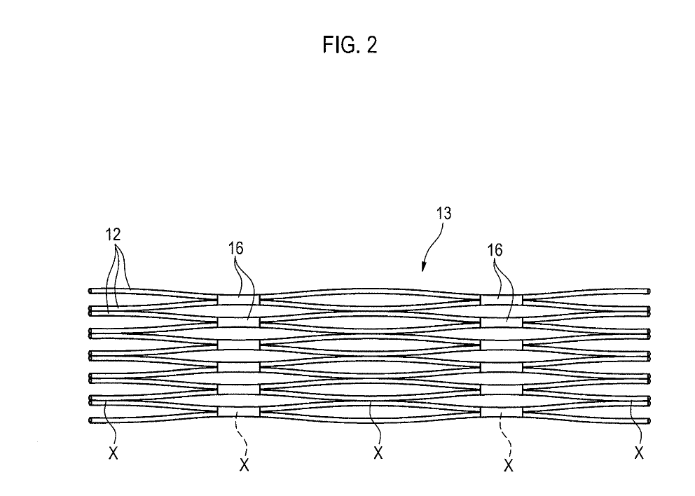

FIG. 1 is a sectional view of an optical fiber cable 10 for air blow installation according to the exemplary embodiment. FIG. 2 is a plan view of an optical fiber ribbon 13 configuring the optical fiber cable 10 for air blow installation.

The optical fiber cable 10 for air blow installation of the exemplary embodiment shown in FIG. 1 is an optical fiber cable for air blow installation (ABF cable: Air Blown Fiber cable) to be installed in a duct located in advance by blowing the compressed air into the duct so that the optical fiber cable rides on an air flow in the duct. The optical fiber cable 10 for air blow installation (which is hereinafter called as optical fiber cable) has a plurality of (four, in the exemplary embodiment) optical fiber assemblies 11. The optical fiber assemblies 11 have a plurality of (twelve, in the exemplary embodiment) optical fibers 12, respectively. The optical fiber 12 is configured by coating a resin around a glass fiber consisting of a core and a cladding. The optical fiber assemblies 11 are configured by optical fiber ribbons 13 respectively and are stranded to configure an optical ribbon assembly 14. A jacket 15 made of a foamed resin such as foamed polyethylene and the like is provided around the plurality of optical fiber assemblies 11 and around the optical ribbon assembly 14 consisting of the optical fiber assemblies 11. Thereby, the optical fiber assemblies 11 and the optical ribbon assembly 14 are covered around there with the jacket 15.

As shown in FIG. 2, the optical fiber ribbon 13 configuring the optical fiber assembly 11 includes the plurality of optical fibers 12 arranged in parallel. The optical fiber ribbon 13 is formed by intermittently cutting coupling parts of the optical fibers 12, which are arranged in parallel and integrated, in a longitudinal direction. In the optical fiber ribbon 13 of the exemplary embodiment, the optical fibers 12 adjacent to each other are intermittently coupled to each other at alternately different positions X in the longitudinal direction. In the meantime, an optical fiber ribbon of which the optical fibers 12 adjacent to each other are intermittently bonded to each other, for example, by adhesive or the like may be used as the optical fiber ribbon 13. In this case, the optical fibers 12 adjacent to each other may be intermittently coupled to each other at alternately different positions in the longitudinal direction.

The optical fiber ribbon 13 is provided with identification marks 16. The identification mark 16 is provided at the coupling part of the optical fibers 12 adjacent to each other. In the exemplary embodiment, the identification marks 16 are intermittently provided in the longitudinal direction of the optical fiber ribbon 13. The identification marks 16 have different colors between the respective optical fiber ribbons 13. Thereby, each optical fiber ribbon 13 can be identified by the color of the identification mark 16. In the meantime, the identification marks 16 may have different patterns between the respective optical fiber ribbons 13. In this case, each optical fiber ribbon 13 can be identified by the pattern of the identification mark 16.

The optical fiber ribbon 13 has a bundle shape of which a sectional shape is circular by collecting together the optical fibers 12 adjacent to each other and configures the optical fiber assembly 11. In the optical fiber ribbon 13 of the exemplary embodiment, the optical fibers 12 adjacent to each other are intermittently coupled at the alternately different positions in the longitudinal direction. Therefore, when assembling the optical fibers 12, the optical fibers 12 are easily closely assembled to each other. The optical fiber ribbon 13 is covered around there by the jacket 15 made of the foamed resin at a state where the optical fibers 12 are assembled to configure the optical fiber assembly 11.

The optical fiber cable 10 of which the optical fiber assemblies 11 are covered with the jacket 15 is provided with concavo-convex parts 17 on a surface of the jacket 15. The concavo-convex part 17 has a shape conforming to an outward shape of the outermost periphery optical fiber 12 of the optical ribbon assembly 14 made by stranding the optical fiber assembly 11. That is, the concavo-convex part 17 is formed to have an outward shape of the outermost periphery optical fiber 12 of the optical ribbon assembly 14.

When the optical fiber cable 10 is installed in a duct, the optical fiber cable 10 is guided into the duct by blowing the compressed air into the duct.

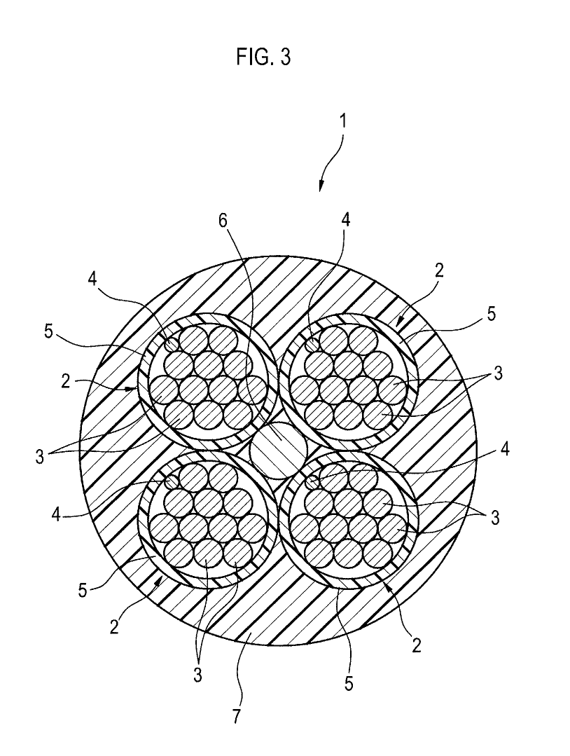

FIG. 3 is a sectional view of an optical fiber cable 1 according to a comparative example.

As shown in FIG. 3, the optical fiber cable 1 according to the comparative example has a plurality of sub-units 2. The sub-unit 2 has a tube 5 in which a plurality of optical fibers 3 and a tearing string 4 are accommodated. The tearing string 4 is to tear the tube 5 when the optical fibers 3 are wired. The sub-units 2 are stranded about an inclusion 6. The stranded sub-units 2 are covered by a jacket 7 made of foamed polyethylene and have a substantially circular section.

According to the optical fiber cable 1 of the comparative example, the sub-unit 2 has the tube 5 and the tearing string 4. For this reason, a weight and a diameter of the optical fiber cable 1 are inevitably increased. According to the configuration where the four sub-units 4, each of which accommodates therein the twelve optical fibers 3, are provided to increase communication data capacity, like the comparative example, it is not possible to avoid the increase in the weight and diameter of the cable.

Also, the optical fiber cable 1 has the substantially circular section and the jacket 7 has a smooth outer periphery. For this reason, when the optical fiber cable 1 having a large diameter is enabled to pass through a duct, a contact area between the outer periphery of the cable 1 and an inner periphery of the duct is large and the friction with the duct is thus increased.

Therefore, when the optical fiber cable 1 of the comparative example is installed in the duct by blowing the compressed air into the duct, the optical fiber cable is difficult to ride on an air flow, so that the installation operation may not be performed smoothly and favorably.

In contrast, according to the optical fiber cable 10 of the exemplary embodiment, the plurality of optical fibers 12 is collectively accommodated by using the optical fiber ribbon 13 of which the plurality of optical fibers 12 is intermittently coupled to each other in the longitudinal direction, without using the tube like the comparative example. Since the optical fiber ribbon 13 has the plurality of optical fibers 12, which is integrated but intermittently coupled to each other in the longitudinal direction, it is possible to easily form the optical fiber assembly 11 having a small diameter by assembling the optical fibers 12 adjacent to each other. Also, it is not necessary to provide the tube for accommodating therein the optical fibers 12 and the tearing string for tearing the tube, so that it is possible to remarkably reduce a weight of the cable. Further, the jacket 15 is made of the foamed resin, so that the cable can be made to be light. Thereby, when the optical fiber cable is installed in the duct by blowing the compressed air into the duct, the optical fiber cable is easy to ride on the air flow, to perform the installation operation smoothly and favorably and to extend an air blow installation distance. In the exemplary embodiment, since the optical fibers 12 adjacent to each other are intermittently coupled to each other at the alternately different positions in the longitudinal direction, it is easier to assemble the adjacent optical fibers, so that it is possible to easily form the optical fiber assembly having a small diameter.

Also, when the optical fiber ribbon 13 is rubbed in the longitudinal direction by a brush, for example, the coupling parts of the optical fibers 12 are separated and the optical fibers 12 can be thus easily individually separated, so that the terminal processing can be easily performed.

Further, since the concavo-convex parts 17 are formed on the surface of the jacket 15, it is possible to reduce the contact area with the inner surface of the duct as much as possible when the cable is installed in the duct by blowing the compressed air into the duct. Thereby, it is possible to suppress the friction with the inner surface of the duct when the cable is installed in the duct by blowing the compressed air into the duct, so that it is possible to perform the installation operation smoothly and favorably and to further extend the air blow installation distance.

Also, the optical ribbon assembly 14 obtained by stranding the plurality of optical fiber assemblies 11 is provided to reduce the weight and diameter of the entire cable and to increase the data communication capacity. Therefore, it is possible to meet the needs for the increase in the data communication capacity. Further, since it is possible to reduce the weight and diameter of the entire cable, even though the plurality of optical fiber assemblies 11 is provided to increase the data communication capacity, it is possible to perform the installation operation smoothly and favorably and to extend the air blow installation distance when the cable is installed in the duct by blowing the compressed air into the duct.

Specifically, the four optical fiber ribbons 13, each of which has the twelve optical fibers 12, are provided, so that a total of forty eight (48) optical fibers 12 are provided. Thereby, the data communication capacity is increased, so that it is possible to meet the needs for the increase in the data communication capacity.

Also, it is possible to easily identify the optical fiber assemblies 11 composed of the optical fiber ribbons 13 and to smoothly perform the wiring operation at the terminal by seeing the identification marks 16 provided for the optical fiber ribbons 13.

For example, the optical fiber cable 10 of the exemplary embodiment having the four optical fiber ribbons 13, each of which has the twelve optical fibers 12, was manufactured. Also, the optical fiber cable 1 of the comparative example having four sub-units 2, each of which has the twelve optical fibers 3, was manufactured.

As a result, a maximum diameter of the optical fiber cable 10 of the exemplary embodiment could be suppressed to about 4.0 mm, so that it was possible to reduce the weight by about 10%, as compared to the optical fiber cable 1 of the comparative example.

Also, an air blow installation test for installing the optical fiber cable 10 of the exemplary embodiment and the optical fiber cable 1 of the comparative example in the duct by blowing the compressed air into the duct was carried out. As a result, it was confirmed that the air blow installation distance of the optical fiber cable 10 of the exemplary embodiment was extended by about 20%, as compared to the optical fiber cable 1 of the comparative example

In the meantime, the number of the optical fibers 12 configuring the optical fiber ribbon 13 and the number of the optical fiber ribbons 13 are not limited to the above. For example, the four optical fiber ribbons 13 each of which has six optical fibers 12 may be provided. In this case, the twelve four (24) optical fibers 12 are provided to increase the communication data capacity, so that it is possible to meet the needs for the increase in the data communication capacity.

Also, at least one of the optical fiber assembly 11 and the optical ribbon assembly 14 may be covered by a fiber-like material.

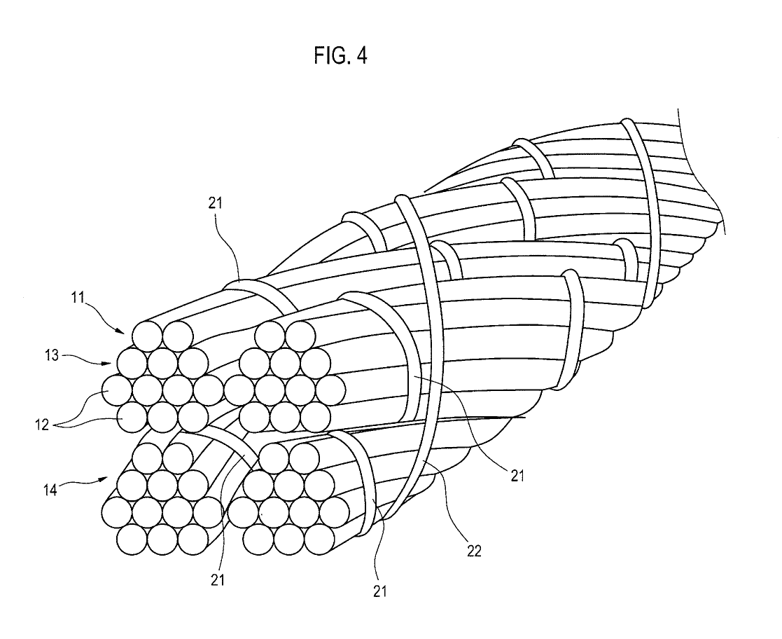

FIG. 4 is a perspective view of the optical ribbon assembly 14 of the optical fiber cable 10 according to a modified embodiment.

As shown in FIG. 4, according to the optical fiber cable 10 of the modified embodiment, a fiber-like material 21 such as a string made of polyester is spirally wound on each of the optical fiber assemblies 11 configuring the optical ribbon assembly 14. Thereby, the optical fiber assembly 11 is unified with the optical fibers 12 being assembled by the fiber-like material 21. Also, in the modified embodiment, a fiber-like material 22 such as a string made of polyester is spirally wound on the optical ribbon assembly 14 of which the optical fiber assemblies 11 are stranded. Thereby, the optical ribbon assembly 14 is unified with the optical fiber assemblies 11 being stranded by the fiber-like material 22.

According to the modified embodiment, the fiber-like material 21 is wound on the optical fiber assembly 11, so that it is possible to unify the optical fiber assembly 11. Thus, it is possible to easily handle the optical fiber assembly 11 when the cable is installed. Also, it is possible to easily manufacture the cable. Further, when colors of the fiber-like materials 21 are made to be different for each of the optical fiber assemblies 11, it is possible to easily identify the respective optical fiber assemblies 11.

Also, the fiber-like material 22 is wound on the optical ribbon assembly 14 consisting of the plurality of optical fiber assemblies 11, so that it is possible to unify the optical ribbon assembly 14 and to easily handle the same when the cable is installed. Also, it is possible to manufacture the cable more easily.

Subsequently, a method of manufacturing the optical fiber cable 10 is described.

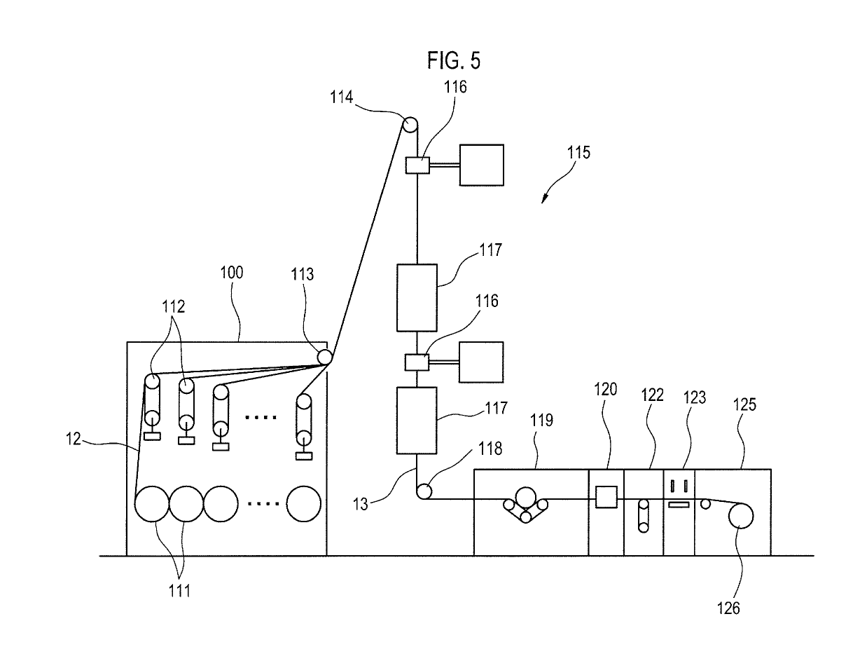

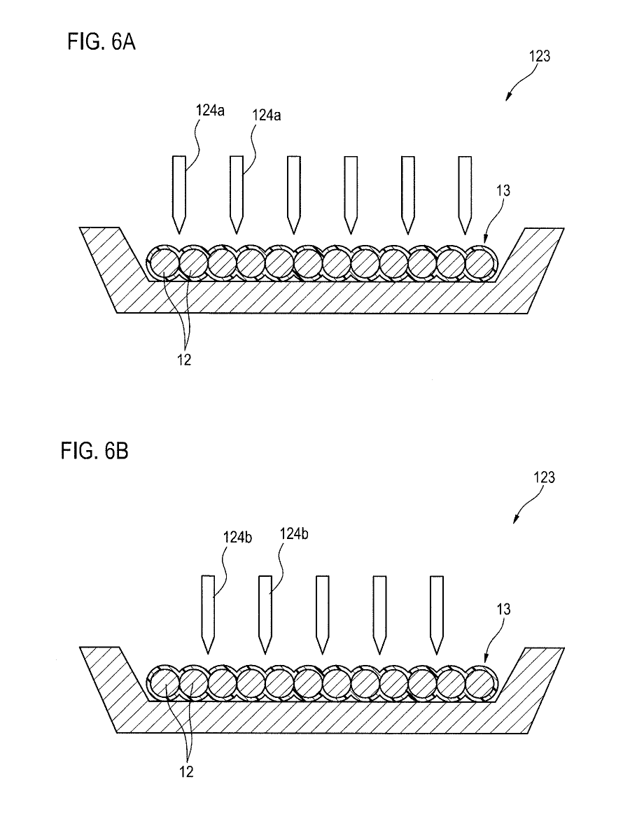

FIG. 5 is a schematic configuration view of an apparatus of manufacturing the optical fiber ribbon 13. FIGS. 6A and 6B illustrate cutting processes of an intermittent processing apparatus 123, in which FIG. 6A is a sectional view of the optical fiber ribbon 13 in a width direction at cutting parts by upstream-side cutters 124a, and FIG. 6B is a sectional view of the optical fiber ribbon 13 in the width direction at cutting parts by downstream-side cutters 124b.

As shown in FIG. 5, the manufacturing apparatus of the optical fiber ribbon 13 has a supply device 100. The supply device 100 is provided with twelve reels 12 on which the optical fibers 12 are respectively wound. Also, the supply device 100 is provided with dancer rollers 112 and a guide roller 113 for guiding the optical fibers 12 unwound from the respective reels 112.

The twelve optical fibers 12 are unwound from the reels 111 and tensions thereof are respectively adjusted by the dancer rollers 112. Then, the twelve optical fibers 12 are guided by the guide roller 113 and conveyed to a fiber assembling roller 114. The twelve optical fibers 12 are assembled and arranged in parallel at the fiber assembling roller 114 and are then conveyed to a tape resin applying apparatus 115.

In the tape resin applying apparatus 115, the twelve optical fibers 12 pass through a die 116, so that an ultraviolet curable resin is applied around the twelve optical fibers 12 arranged in parallel with being closely contacted on one plane. The twelve optical fibers 12 to which the ultraviolet curable resin has been applied in the die 116 is illuminated with the ultraviolet in an ultraviolet illumination reactor 117, so that the ultraviolet curable resin is cured and the optical fiber ribbon 13 having twelve fibers is manufactured. The optical fiber ribbon 13 is conveyed to an identification mark applying apparatus 120 via a guide roller 118 and a delivery capstan 119. In the exemplary embodiment, the dies 116 and the ultraviolet illumination reactors 117 are provided two by two and the optical fibers 12 arranged in parallel are applied twice with the resin, which are then integrated. However, the die 116 and the ultraviolet illumination reactor 117 may be provided one by one and the optical fibers 12 arranged in parallel may be applied once with the resin, which are then integrated.

In the identification mark applying apparatus 120, the colored resin is intermittently applied to the optical fiber ribbon 13 being conveyed, so that the identification marks 16 are provided to the optical fiber ribbon 13.

The optical fiber ribbon 13 having the identification marks 16 applied thereto is conveyed to an intermittent processing apparatus 123 via a winding tension control dancer roller 122.

The intermittent processing apparatus 123 is configured to intermittently cut the coupling parts of the optical fibers 12 of the optical fiber ribbon 13 in the longitudinal direction, so that the optical fibers 12 adjacent to each other are intermittently coupled at alternately different positions in the longitudinal direction.

Specifically, as shown in FIG. 6A, the coupling parts of the optical fibers 12 are intermittently cut alternately in the width direction by a plurality of cutters 124a provided at an upstream side of the intermittent processing apparatus 123. Also, as shown in FIG. 6B, the coupling parts of the optical fibers 12, which deviate in the width direction from the coupling parts of the upstream-side cutter 124a by one optical fiber 12, are intermittently cut alternately in the width direction by a plurality of cutters 124b provided at a downstream side of the intermittent processing apparatus 123. Thereby, the optical fiber ribbon 13 of which the optical fibers 12 adjacent to each other is intermittently coupled at alternately different positions in the longitudinal direction is obtained.

The optical fiber ribbon 13 of which the optical fibers 12 adjacent to each other is intermittently coupled at alternately different positions in the longitudinal direction is wound onto a reel 126 of a winding apparatus 125.

The four optical fiber ribbons 13, each of which is manufactured as described above, are assembled to configure the optical fiber assemblies 11. Then, the optical fiber assemblies 11 are stranded to configure the optical ribbon assembly 14. The optical ribbon assembly 14 is covered with a foamed resin such as foamed polyethylene by an extruder, so that the jacket 15 is formed.

By the above processes, it is possible to obtain the optical fiber cable 10 having the optical fiber ribbons 13, each of which has the plurality of optical fibers 12 arranged in parallel and intermittently coupled at the alternately different positions in the longitudinal direction, and the jacket 15 covering the peripheries of the optical fiber assemblies 11, each of which consists of the assembled optical fibers 12 of the optical fiber ribbon 13.

What is claimed is:

1. An optical fiber cable to be installed by air blow installation, the optical fiber cable comprising:
an optical fiber ribbon having a plurality of optical fibers arranged in parallel, the plurality of optical fibers being intermittently coupled to each other in a longitudinal direction, and
a jacket made of a foamed resin and configured to cover a periphery of an optical fiber assembly formed by assembling together the plurality of optical fibers of the optical fiber ribbon.

2. The optical fiber cable according to claim 1, wherein the optical fibers adjacent to each other of the optical fiber ribbon are intermittently coupled to each other at alternately different positions in the longitudinal direction.

3. The optical fiber cable according to claim 1, wherein an optical ribbon assembly obtained by stranding a plurality of the optical fiber assemblies is provided, and
wherein a periphery of the optical ribbon assembly is covered with the jacket.

4. The optical fiber cable according to claim 1, wherein a surface of the jacket is formed with a concavo-convex part having a shape conforming to an outward shape of the optical fiber assembly.

5. The optical fiber cable according to claim 1, wherein the optical fiber ribbon is provided with an identification mark.

6. The optical fiber cable according to claim 1, wherein a fiber-like material is wound on the optical fiber assembly.

7. The optical fiber cable according to claim 3, wherein a fiber-like material is wound on the optical ribbon assembly.

8. The optical fiber cable according to claim 3, wherein the four optical fiber assemblies, each of which includes the optical fiber ribbon having the twelve optical fibers, are stranded to form the optical ribbon assembly.

9. The optical fiber cable according to claim 3, wherein the four optical fiber assemblies, each of which includes the optical fiber ribbon having the six optical fibers, are stranded to form the optical ribbon assembly.
